(19) United States
(12) Patent Application Publication
(10) Pub. No.: US 2009/0324781 A1
(43) Pub. Date: Dec. 31, 2009

(54) APPARATUS AND METHOD OF TOASTING SANDWICHES WITHOUT HEATING THE SANDWICH FILLING

(76) Inventors: Jonathan N. Soudry, Lutherville, MD (US); Michael O'Banion, Westminister, MD (US); Daniel Stafford O'Banion, Westminister, MD (US)

Correspondence Address: HODES, PESSIN & KATZ, P.A., Suite 400, 901 Dulaney Valley Road, Towson, MD, 21204, US

(21) Appl. No.: 12/363,829

(22) Filed: Feb. 2, 2009

Related U.S. Application Data
(60) Provisional application No. 61/133,464, filed on Jun. 30, 2008.

(51) Int. Cl. A21B 1/26; F24C 15/00; A21D 13/00

(52) U.S. Cl. 426/94; 219/400; 219/392

(57) ABSTRACT

An apparatus and method of preparing and serving a sandwich which is prepared in advance and stored in a refrigerator. The sandwich is toasted in a heating apparatus such that the bread is selectively toasted while the contents remain substantially cold. The toasting apparatus has a heater, a blower and duct to heat the air and direct it to the sandwich. The sandwich is in a basket received in a recess wherein.

### CROSS REFERENCE TO RELATED APPLICATIONS

The present invention is related to Provisional Patent Application Ser. No. 61/133,464 filed Jun. 30, 2008

### BACKGROUND OF THE INVENTION

The present application is directed to a device and a method of preparing toasted sandwiches and more particularly is intended primarily for the restaurant business, basically an industrialized setting, and not intended for the home.

1. Description of Related Art

Some sandwiches are made up, per a customer's order, as for example, Subway. The bread is baked on the premises and serve warm, and the sandwich is made up in front of the customer. The sandwich is appetizing, but requires time, labor and hence costs.

Other restaurants sell already made-up sandwiches kept in refrigerated case, as for example, Starbucks. There, the sandwich is served cold or else is heated completely in a microwave oven, in which case the contents are also heated up. Either way, it's not too appetizing (albeit fast).

Existing products warm up the inside of the sandwich as well as the outside (bread).

The disadvantage of this is that it is not possible to toast the bread and keep the filling cold, such as lettuce and tomato, chicken salad and tuna salad which is supposed to be cold.

The applicant is aware of the following patents, all of which heat the bread/roll as well as the filling of the sandwich.

| Inventor | U.S. Pat. No. |
|---|---|
| Orkfritz | 2,329,937 |
| Vaughan | 2,243,137 |
| Evans | 2,640,905 |
| Brezinski | 3,994,213 |
| Woods | 4,015,085 |
| Gallina | 4,297,941 |
| Plattner | 4,437,396 |
| Mauffrey et al | 6,649,977 |

Cooking or toasting the exterior of food (such as a sandwich) without heating the interior ingredients of the food requires a substantial amount of heat to quickly toast or cook the food without heating the internal ingredients. The preferred method of cooking is with heated air flowing over the outside of the food for a period of time. The air must be heated to between 300° F. to 550° F. to toast the food to the desired toasted condition in a reasonably short period of time of between 1 to 3 minutes. This substantial amount of heat, if allowed to escape to the room in which the cooking device is located will increase air conditioning load requirements of the room environment and also require a greater amount of energy to provide the necessary high temperature. Also, the contents of the sandwich may become heated when it is desired that the contents remain cool (fresh vegetables, chicken salad, fish). Also, the bread may not be toasted to a crisp surface.

### SUMMARY

In the present application, there is a standard format or design for a sandwich, which is completely pre-made, basically tubular like a sub or hoagie roll, and kept refrigerated. When ordered by a customer, the sandwich is placed in a wire sleeve, and then the sleeve is placed in a semi-cylindrical opening of a specially-designed toaster apparatus. The present invention has a box with heating elements and a fan that projects air over the heating elements in order to heat the air. The hot air is released through the openings in the cylinders on top of the box, into which the sandwich is inserted. With the proper time, heat flow, etc., only the bread is toasted (and golden brown) while the inside ingredients are still cold.

In accordance with the teachings of the present invention, there is disclosed the method of preparing and serving a delicious sandwich selected by a customer. The sandwich is prepared in advance and stored in a refrigerated container. Each of the sandwiches has a substantially standard configuration and the selected sandwich includes cold, fresh contents sandwiched within a roll. The selected sandwich is heated such that the roll selectively becomes toasted, the contents remain substantially cold, and the sandwich is tasty and appetizing.

In further accordance with the teachings of the present invention, there is disclosed a device for heating a ready-made refrigerated sandwich selected by a customer. The sandwich has a filling encased within a bread exterior. A container is provided having insulated walls, an insulated top, internal ducting, a blower mounted on a selected wall and an air heating means within the container such that heated air is circulated within the container. At least one tray is disposed within the container, the at least one tray being accessible from the exterior of the container. The at least one tray has sidewalls, the sidewalls having a plurality of holes formed longitudinally therein. At least one foldable wire basket is removably disposed in the at least one tray. The at least one wire basket has two longitudinal portions hingeably connected to one another. A crumb tray is removably disposed under the at least on tray. The sandwich may be disposed in the at least one wire basket, the bread of the sandwich being spaced apart from the at least one tray. The heated air passes through the plurality of holes in the at least one tray and around the sandwich, thereby toasting the bread of the sandwich without substantially heating the filling of the sandwich.

In still further accordance with the teachings of the present invention, there is disclosed the combination of a toasting apparatus having a top surface provided with at least one substantially semi-cylindrical recess with at least one opening formed therein. A pre-made sandwich having a substantially cylindrical design, is normally being kept substantially refrigerated. The sandwich is placed in the substantially semi-cylindrical recess in the toasting apparatus. Warm air passes through the at least one opening in the substantially-cylindrical recess, with the result that substantially only the bread is toasted while the contents of the sandwich are maintained cool for a tasty, appetizing and refreshing meal.

In addition, in accordance with the teachings of the present invention, there is disclosed a restaurant or fast-food environment, wherein sandwiches including a roll or other bread having a substantially standard shape and size with contents of the sandwich are prepared and transported in a refrigerated condition to a distribution network of retail outlets and stored therein. A sandwich is selected by a customer in a particular retail outlet and delivered to the customer. The improvement comprises the step of heating the entire selected sandwich such that the roll is toasted and the roll has a pleasing appearance and feel, and such that the contents of the sandwich remain substantially fresh, cold and appetizing without having to prepare the sandwich on site at the particular retail outlet.

These and other objects of the present invention will become apparent from a reading of the following specification taken in conjunction with the enclosed drawings.

### BRIEF DESCRIPTION OF THE DRAWINGS

FIG. 1 is a perspective view showing the preparation of a sandwich with the contents to be placed within a roll and an oven to heat the assembled sandwich.

FIG. 2 is a perspective view showing the removal of the heated assembled sandwich from the oven.

FIG. 3 is a perspective view of the device of the present invention.

FIG. 4 is a exploded view of the device of the present invention.

FIG. 5 is a cross sectional view taken across the lines 5-5 of FIG. 3.

FIG. 6 is a cross-sectional view taken across lines 6-6 of FIG. 3.

FIG. 7 is a diagram of the method of the present invention.

FIG. 8 is a sequence view of the method of the present invention.

FIG. 9 is a perspective view of the heating tray.

FIG. 10 is a sequence view of the sandwich received in the wire tray.

FIG. 11 is the electrical wiring diagram of the convection embodiment of the present invention.

FIG. 12 is a perspective view of an alternate embodiment of the heating tray.

FIG. 13 is a cross-sectional view of the heating tray of an alternate embodiment.

FIG. 14 is the electrical wiring diagram of the radiant heating embodiment.

### DESCRIPTION OF THE PREFERRED EMBODIMENTS

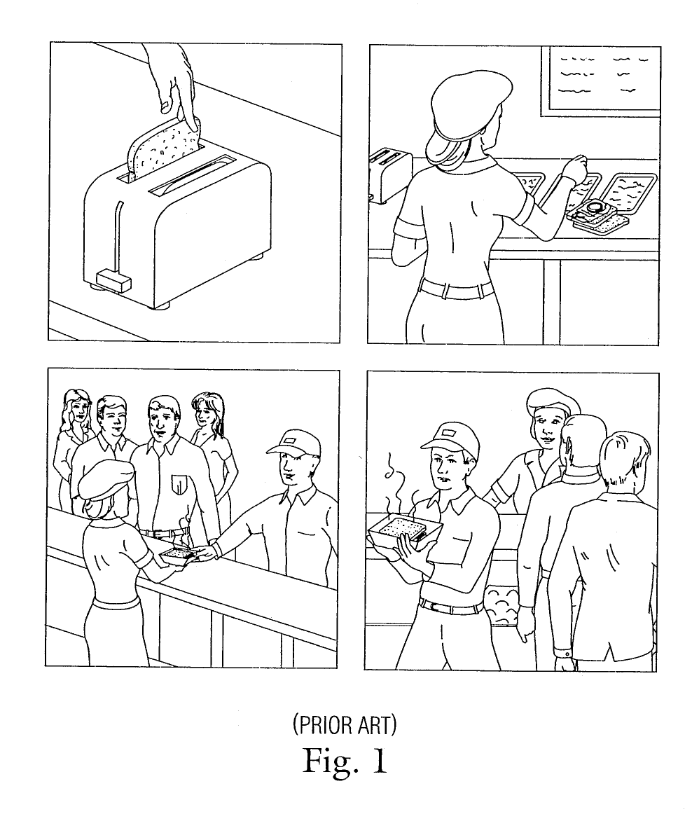

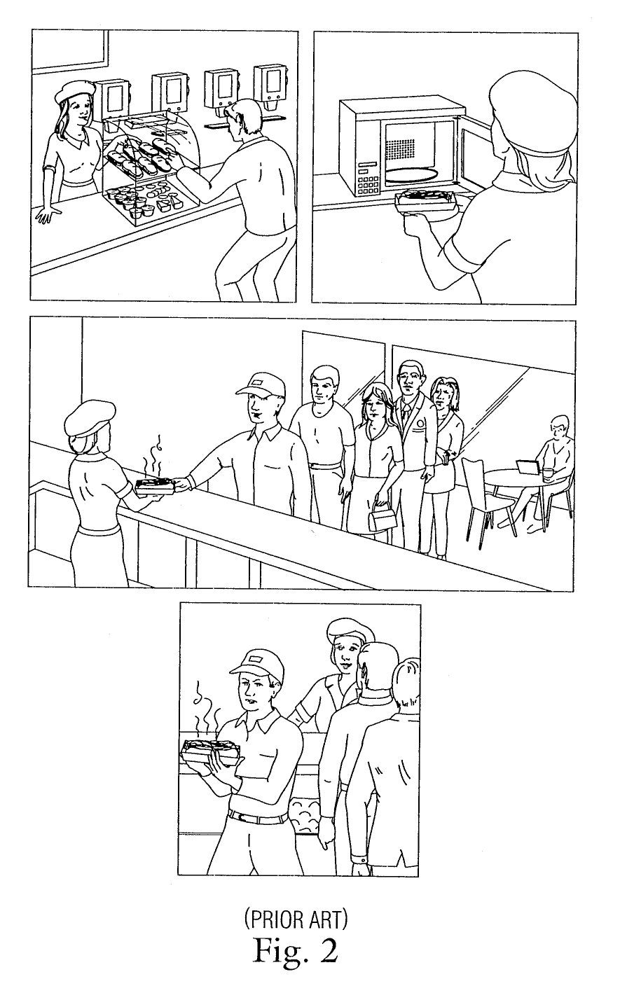

Referring to FIG. 1 and 2 in the prior art, a customer in a restaurant or carry-out food shop orders a sandwich which is prepared when the order is received using slices of bread or a roll. The contents of the sandwich (e.g. cheese, meat, salad) are placed in the roll or between the bread. The assembled sandwich is placed in an oven or toaster and the entire sandwich, including the filling is heated. This is a labor intensive procedure and the customer receives a sandwich which has a heated filing. If the filling has materials which are preferred to be unheated and which do not taste good when heated (e.g. lettuce, tomato, cucumbers, tuna salad, chicken salad), the sandwich is less appetizing. An alternative is to toast the bread or roll and then add the filling. This is labor intensive and, during the time the sandwich is being assembled, the heated bread or roll cools and the sandwich is unappetizing. Some fast-food or carry-out shops have pre-made sandwiches in a refrigerator. The customer selects a sandwich which is eaten cold or is heated in an oven, a microwave or by an infra-red lamp. Any of these procedures heat the filling of the sandwich and provide a less appetizing product.

The present invention solves this problem by having prepared sandwiches stored in a refrigerator. A selected sandwich is heated in a specially designed heating apparatus which heats and toasts the bread or roll without heating the contents of the sandwich. The customer receives a sandwich with warm toasted bread and a cold, crisp filling. The preassembled sandwich does not require time to prepare while the customer is waiting. The present invention provides efficiency of production of sandwiches at reduced cost combined with customization of toasting the bread for customer satisfactions.

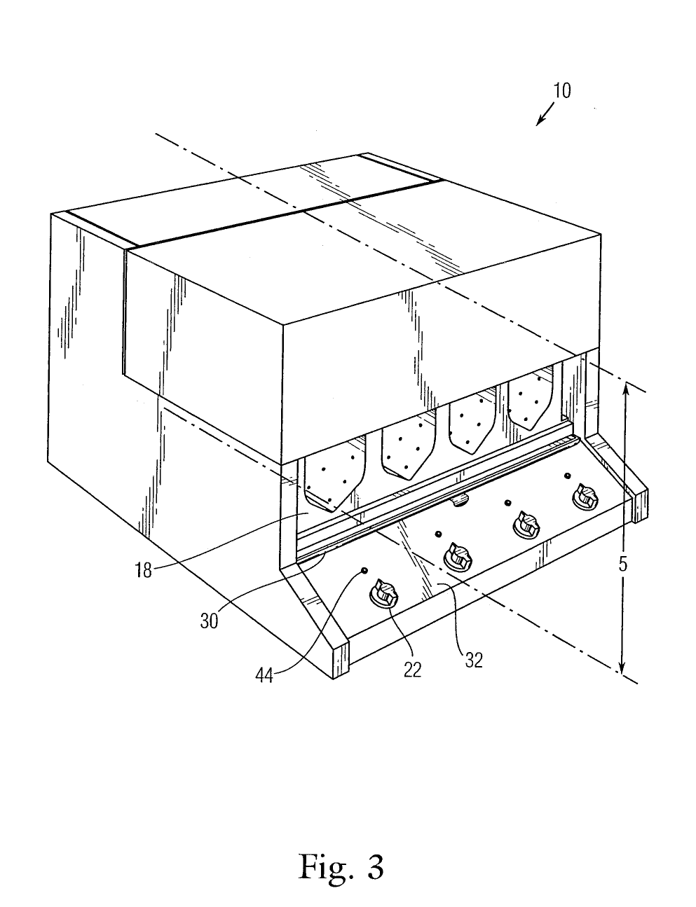

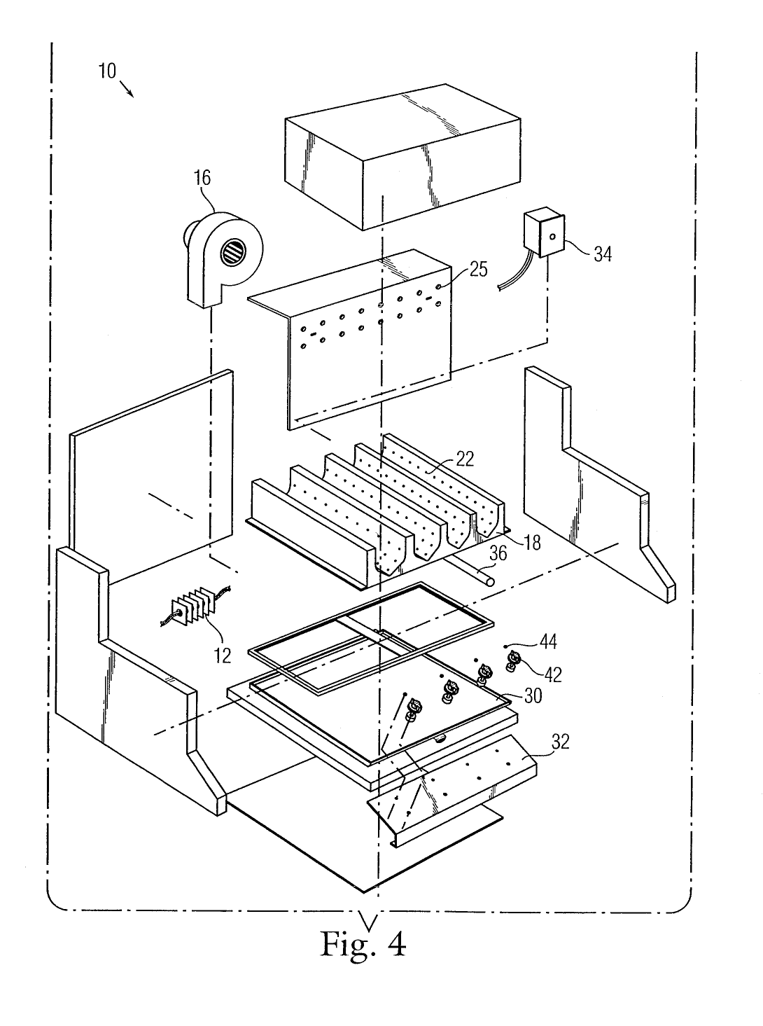

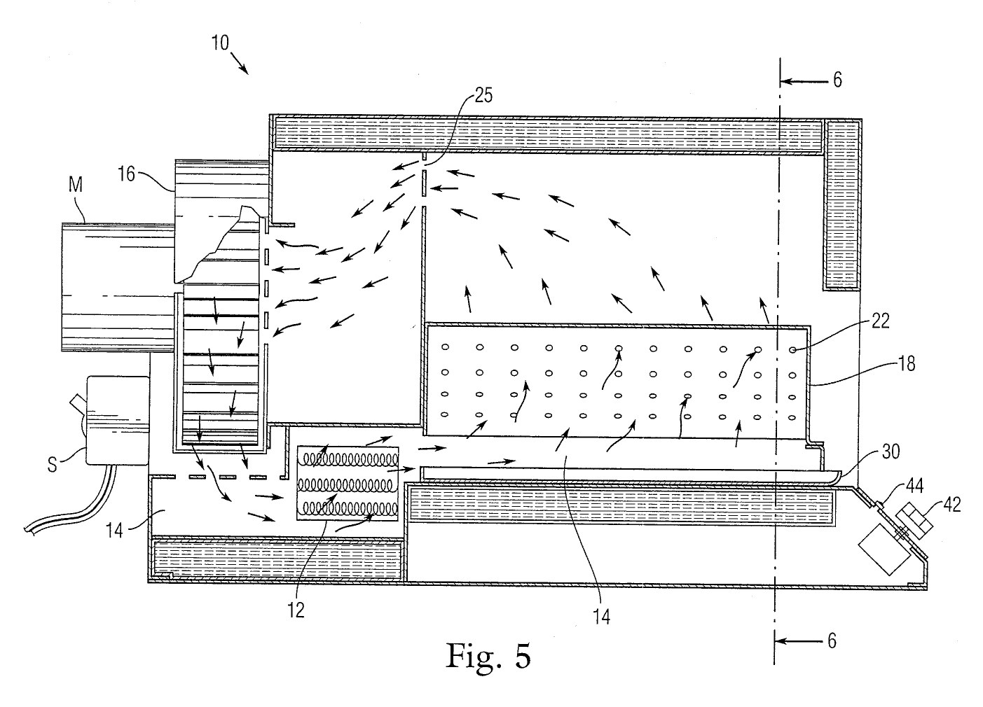

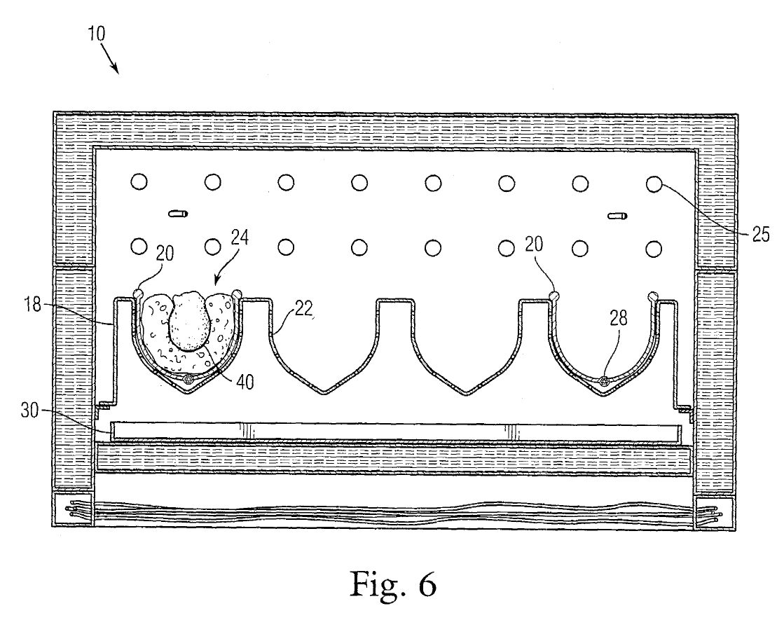

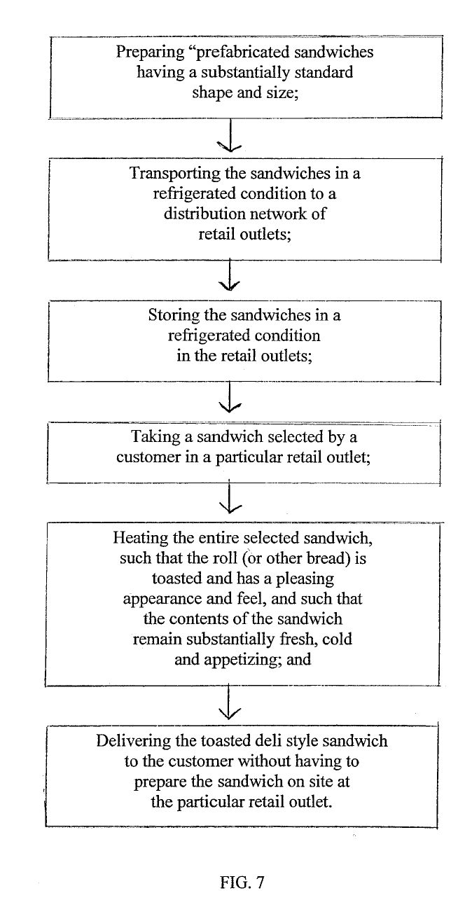

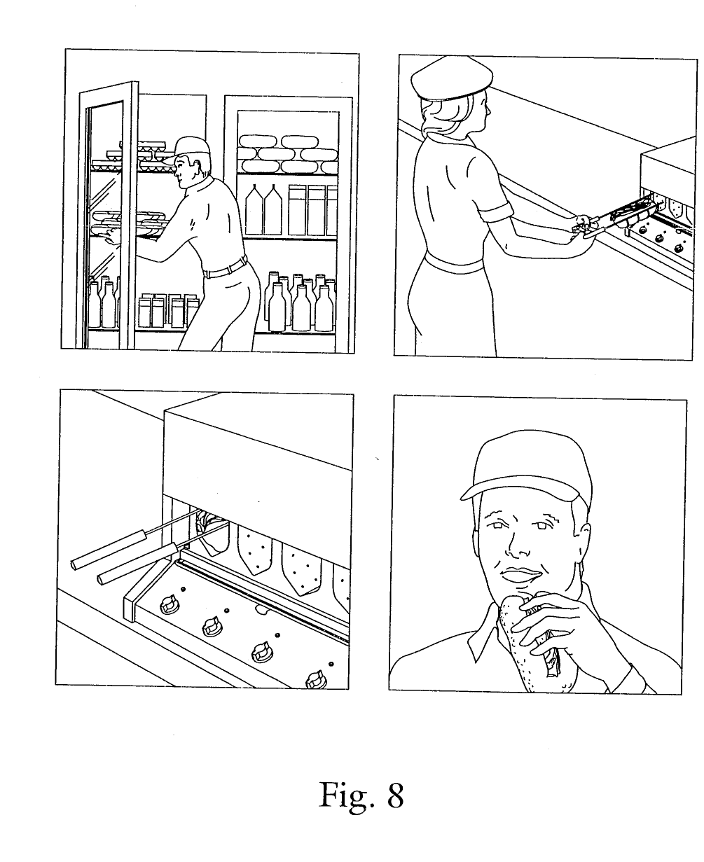

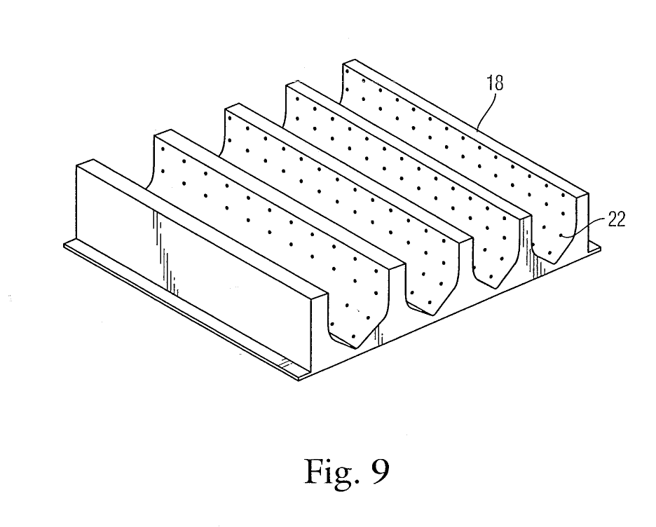

As shown in FIG. 3-6 the heating apparatus is preferably a stainless steel container having an insulated top and walls to reduce heat loss from the container. This is very important to improve the efficiency of operation of the apparatus and to conserve energy. Also, it is important for the environment in which the apparatus is used, for the comfort of employees and for operation in an air conditioned environment. At least one heating element is provided. Preferably, the heating element is an electrical resistance type heater with fins to more effectively transfer the heat to air passing over the heating element. However, open flames such as a gas burner or other heating means known to persons skilled in the art may be used. A heating element made by Vulcan Manufacturing, part no OSF 1512-900A has been used satisfactorily. The device also has an air containment means such as ducts 14 and chambers through which heated air is moved. The device has a Motor M driven blower 16 to move the air. A blower made by Dayton, part no ITD V3 has been used satisfactorily. The blower moves the air in the container over the heating means. The heated air is directed through the ducts to the chamber under the cooking tray 18. The cooking tray is, preferably, an elongated, substantially U-shaped form made of stainless steel. A plurality of cooking trays may be provided formed from a single sheet of metal. A plurality of holes 22 are formed along the length of the sidewalls of each cooking tray wherein the heated air is directed around a wire basket 20 received in the heating tray. Each hole is approximately 0.06-0.25 inches in diameter. A sandwich 24 is disposed in the wire basket such that the sandwich is spaced apart from the heating tray 18 and the heated air passes over the outer surface of the entire sandwich to toast the bread of the sandwich by convection while not heating the filling or contents of the sandwich. The heated air flows to the chamber above the heating tray. This chamber has a back wall with a series of openings 25 formed therein. The openings permit the air to flow back to the blower such that the heated air is recycled within the container for greater efficiency. The openings 25 in the back wall of the chamber may be adjustable in size to provide a means of controlling the flow rate of the air within the container 10. The flow rate of the air within the container is approximately 10 cfm for each cooking tray but the flow rate is not critical.

It is preferred that the heating tray 18 be elongated and have uniform inner dimensions to receive bread having a corresponding shape. French style rolls have been used satisfactorily in the device. However, sandwiches and cooking trays which are circular, rectangular, square and have other shapes may be used. It is further preferred that the bread of the sandwich have respective upper and lower portions 40, at least one portion of which is hollowed out. In this manner, the contents of the sandwich (the filling) is retained more positively in the sandwich while the bread is toasted on the outside.

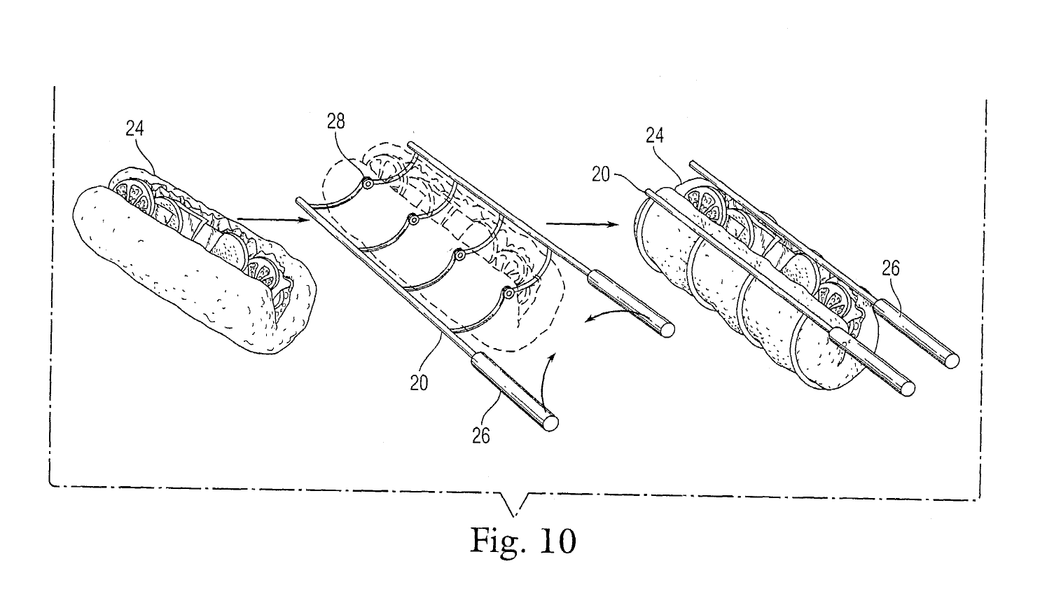

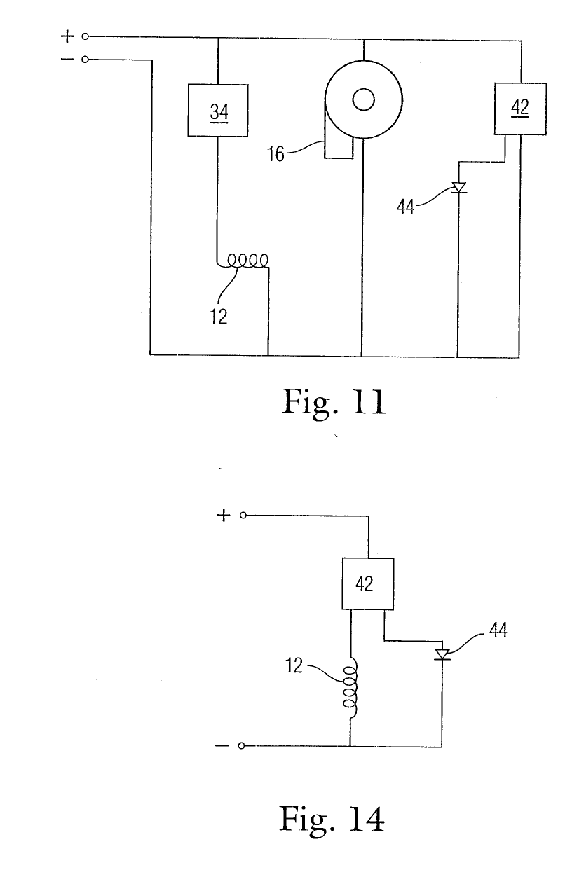

In order to allow the insertion and removal of the sandwich from the basket 20 without burning the fingers or hands of the person using the apparatus, the basket 20 has been formed with handles 26 and a hinge 28 such that the basket is opened like a book allowing easy insertion of the food to be cooked. (FIG. 10) The hinged wire basket is closed until it is in contact to the food. It is preferred that the wire basket be made from stainless steel. The wire basket can be washed with soap and water. The wire basket is inserted into the hot cooking chamber until the food is cooked to the desired degree. The person removes the food and wire basket by means of holding the handles, lifting the food and basket, removing it from the heated cooking chamber and placing it on a cool surface, opening the basket allowing easy removal of the cooked food. The disclosed wire basket may have one or more hinge axes to allow the basket to conform to several shapes of food to be cooked, for example a tubular shaped food or a rectangular shaped food.

Alternate means for insertion and removal of the basket and food is disclosed by providing a linear sliding means to guide the basket into and out of the cooking means. The basket is moved by means of any one of a multitude of well known mechanisms including, for example, a lever actuated mechanism or a motor actuated linear screw mechanism.

A crumb tray 30 is disposed under the heating tray to collect crumbs and other material which may fall from the sandwich. The crumb tray 30 is removable by pulling it outwardly from the front of the container. A tab is formed on the front of the crumb tray to assist in removing the crumb tray from the cabinet. Preferably, the crumb tray is formed from stainless steel.

The apparatus is provided with a control panel 32 to increase the versatility of the device. An on-off power switch S is provided. A timer 42 and pilot light 44 is included for each cooking tray 18 so that the operator can set the time when a sandwich is placed in a respective heating tray and, after a predetermined time, the pilot light is extinguished and an audible signal is given. The time of heating can be adjusted to determine whether the bread is toasted light, medium or dark. An Intermatic Time model FF5M has operated satisfactorily. A Thermostat 34 and a Thermostat sensor 36 are disposed within the container to control the temperature adjacent to the sandwich to approximately 300-550° F. Vulcan Manufacturing Thermostat no. Ni5/3015-3 has been found to perform satisfactorily. It is preferred that the temperature is preset but can be adjusted. Testing has shown that the temperature of the filling of the sandwich is approximately 40° F. when the pre-made sandwich is removed from the refrigerator. After approximately 2-3 minutes in the wire basket with the heated air passing around the sandwich, the bread is toasted and the filling of the sandwich is approximately 45° F. The bread enwraps the filling and acts as a heat insulator for the filling of the sandwich while the bread is being toasted.

The entire assembly of the heating tray 18, wire basket 20 and crumb tray 30 is removable from the container 10 and can be washed and sterilized. The heating tray rests on the frame above the crumb tray; there being no attachment means.

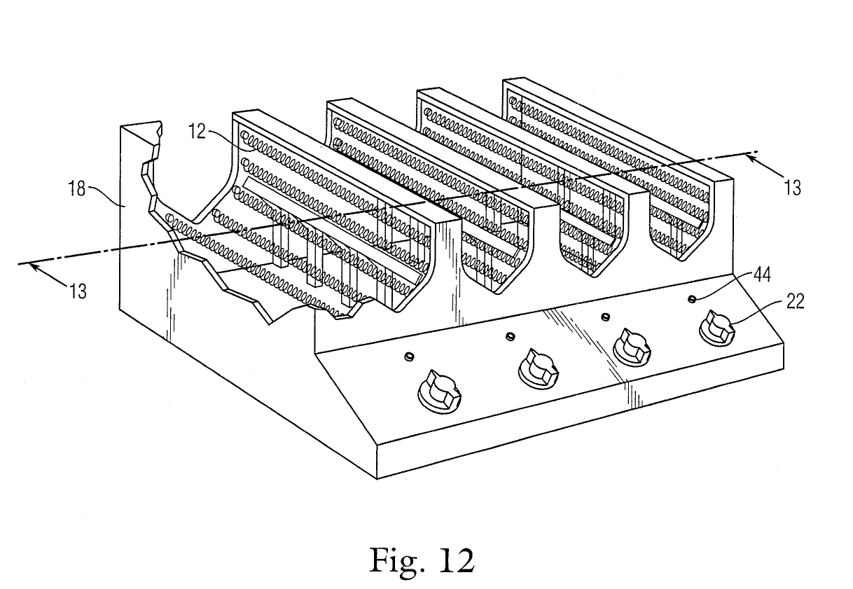

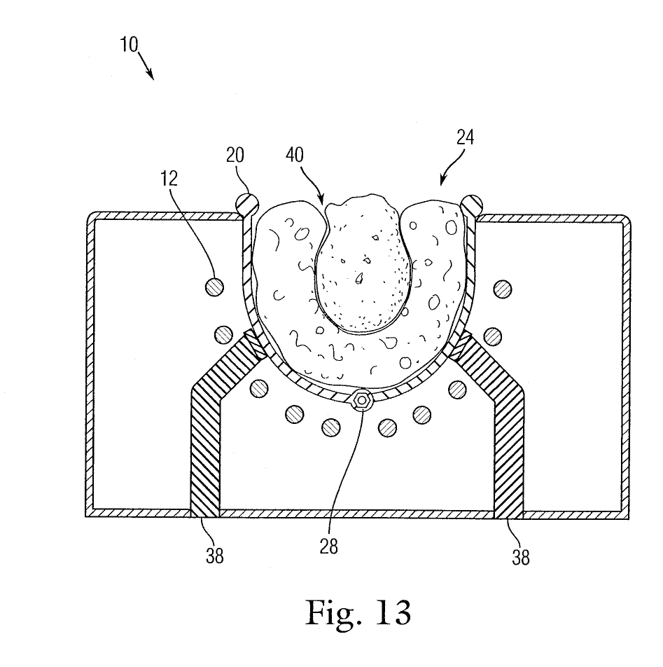

In an alternate embodiment (FIG. 12-14) the heating element is a plurality of electrical resistance elements disposed lengthwise along the tray 18. Support means 38 are formed inside the tray to separate the wire basket from the heating element so that the electrical circuit is intact and the basket does not serve as a heating element. The outer surface of the bread of the sandwich is heated and toasted while the filling of the sandwich remains unheated.

Obviously, many modifications may be made without departing from the basic spirit of the present invention. Accordingly, it will be appreciated by those skilled in the art that within the scope of the appended claims, the invention may be practiced other than has been specifically described herein.

1. A device for heating a ready-made refrigerated sandwich selected by a customer. The sandwich having a filling encased within a bread exterior, comprising;
a container having insulated walls, an insulated top, internal ducting, a blower mounted on a selected wall and an air heating means within the container such that heated air is circulated within the container,
at least one tray disposed within the container, the at least one tray being accessible from the exterior of the container, the at least one tray having sidewalls, the sidewalls having a plurality of holes formed longitudinally therein,
at least one foldable wire basket removably disposed in the at least one tray, the at least one wire basket having two longitudinal portions hingeably connected to one another,
a crumb tray removably disposed under the at least one tray,
wherein the sandwich may be disposed in the at least one wire basket, the bread of the sandwich being spaced apart from the at least one tray, the heated air passing through the plurality of holes in the at least one tray and around the sandwich, thereby toasting the bread of the sandwich without substantially heating the filling of the sandwich.

2. The device of claim 1, wherein the at least one tray is elongated.

3. The device of claim 1, wherein the air is heated to approximately 300-550° F.

4. The device of claim 1, wherein the air is circulated at approximately 10 cfm through the at least one tray.

5. The device of claim 1, wherein each longitudinal portion of the at least one wire basket has a respective handle formed therein, to facilitate placing the at least one wire basket in, and removing the at least one wire basket from, the at least one tray.

6. The device of claim 1, wherein the at least one tray, the at least one wire basket and the crumb tray are removable from the container for washing and cleaning.

7. The device of claim 1, further including a timer such that the bread may be toasted light, medium or dark as selected by the customer.

8. A sandwich made using the device of claim 1.

9. The combination of a toasting apparatus having a top surface provided with at least one substantially semi-cylindrical recess with at least one opening formed therein, and a pre-made sandwich having a substantially cylindrical design, the sandwich normally being kept substantially refrigerated, the sandwich having bread encasing a filling such that the sandwich may be placed in the substantially semi-cylindrical recess in the toasting apparatus, and such that heated air passes through the at least one opening in the substantially-cylindrical recess, with the result that substantially only the bread is toasted while the contents of the sandwich are maintained cool for a tasty, appetizing and refreshing meal.

10. The combination of claim 9, wherein a plurality of substantially cylindrical recesses are formed in the toasting apparatus, thereby accommodating multiple orders in a restaurant environment.

11. The method of preparing and serving pre-made sandwiches in a restaurant environment using the combination of claim 9.

12. The combination of claim 9, wherein the toasting apparatus has a heating element to heat the air, an air moving device to circulate the air over the heating element and an air containment means to duct the heated air in a path through the air moving device and over the heating element in a substantially closed recirculating path.

13. The combination of claim 12, wherein the air is heated to 300° F.-550° F. thereby toasting the bread.

14. The combination of claim 9, wherein the semi-cylindrical recess has a plurality of openings formed therein, each opening having a diameter of approximately 0.06-0.25 inches.

15. The combination of claim 9, further comprising at least one wire basket, the at least one wire basket having two longitudinal portions hingeably connected to one another, each portion having a respective handle formed therein, the sandwich being received in the at least one wire basket and the wire basket containing the sandwich being disposed in the substantially semi-cylindrical recess such that the bread of the sandwich is spaced apart from the semi-cylindrical recess.

16. In a restaurant or fast-food environment, wherein sandwiches including a roll or other bread having a substantially standard shape and size are prepared with contents for the sandwich and transported in a refrigerated condition to a distribution network of retail outlets and stored therein, and wherein a sandwich is selected by a customer in a particular retail outlet and delivered to the customer, the improvement comprising the step of heating the entire selected sandwich such that the roll is toasted and the roll has a pleasing appearance and feel, and such that the contents of the sandwich remain substantially fresh, cold and appetizing without having to prepare the sandwich on site at the particular retail outlet.

17. The improvement of claim 16, wherein the sandwich is heated by hot air circulated within a cabinet.

18. The improvement of claim 16, wherein the sandwich is heated by a radiant heating means.

19. The method of preparing and serving a delicious sandwich selected by a customer, comprising the step of preparing sandwiches in advance and storing the sandwiches in a refrigerated container, each of the sandwiches having a substantially standard configuration and the selected sandwich including cold, fresh contents sandwiched within a roll; and heating the selected sandwich such that the roll selectively becomes toasted, the contents remain substantially cold, and the sandwich being tasty and appetizing.

20. The method of claim 19, wherein the roll is substantially cylindrical and of substantially uniform outer dimensions.

21. The method of claim 20, wherein the roll has respective upper and lower portions, each of which is substantially hollowed out.

22. The method of claim 19, wherein the sandwich is heated by convection.

23. A sandwich made in accordance with the method of claim 19.
